(19) United States
(12) Patent Application Publication
(10) Pub. No.: US 2018/0366033 A1
(43) Pub. Date: Dec. 20, 2018

(54) OBSTETRICAL TRAINING SIMULATOR

(71) Applicant: Operative Experience, Inc., North East, MD (US)

(72) Inventor: Robert F. Buckman, Elkton, MD (US)

(73) Assignee: Operative Experience, Inc., North East, MD (US)

(21) Appl. No.: 16/004,793

(22) Filed: Jun. 11, 2018

Related U.S. Application Data
(60) Provisional application No. 62/522,479, filed on Jun. 20, 2017.

(51) Int. Cl. G09B 23/28

(52) U.S. Cl. CPC G09B 23/281

(57) ABSTRACT

An obstetrical training simulator includes an artificial anatomic structure comprising an artificial tissue structure defining an artificial birth canal that includes an artificial cervix and an artificial vagina. The artificial tissue structure comprises one or more walls enclosing one or more simulated soft tissue spaces. The one or more simulated soft tissue spaces are configured to be reversibly filled with a fluid.

### CROSS-REFERENCE TO RELATED PATENT APPLICATIONS

The present application claims priority to U.S. provisional application Ser. No. 62/522,479, filed Jun. 20, 2017, the entirety of which is hereby incorporated by reference.

### BACKGROUND OF THE INVENTION

This disclosure relates to obstetrical training simulators, and more particularly to obstetrical training simulators that includes an artificial anatomic structure comprising an artificial tissue structure defining an artificial birth canal.

Simulation-based training of medical practitioners has become more common due to advances in computer technologies. Such simulation-based training is useful for preparing medical practitioners for dealing with emergency scenarios, for example, emergency obstetrical procedures. Such emergency obstetrical procedures often involve delicate and potentially injurious interactions between hands of the practitioner and/or instruments used by the practitioner and tissues of a mother and fetus. Operative vaginal delivery in which obstetrical forceps are applied to the fetus within the birth canal is an example of such a procedure. Both the fetus and the maternal birth canal are at risk of serious injury during forceps delivery.

Viscoelasticity is the property of a substance or material that exhibits both viscous and elastic behavior. Application, of a stress causes a temporary deformation of a viscoelastic structure if the stress is quickly removed but a lasting deformation if the stress is maintained.

Visoelastic structures reduce their resistance during prolonged compression and rebound slowly after the pressure is removed. In contrast, elastic structures increase their resistance as (hey are progressively compressed or stretched and rebound immediately. Most clinically-relevant anatomic structures are viscoelastic. Variations in viscoelasticity account for the variable biomechanical properties of tissues in health and disease.

A simple illustration of the viscoelastic behavior of biologic tissues is shown by the effect of a tight rubber band placed around a finger for 30 seconds and then removed. A crease is formed along the circumference of the finger where the rubber band had exerted pressure. This indentation in the tissue recovers over a period of minutes rather than springing back immediately as a purely elastic structure would. This is a viscoelastic phenomenon. Fluid has been displaced from the interstitial spaces in the area where the ligature stress was applied. After the pressure is removed, the fluid slowly returns and, in conjunction with the co-existing elasticity of the interstitial tissues, will gradually restore the linger to its normal contours.

The body fabric, while containing trillions of cells and fibers, is mainly composed of water. The water is both inside the cells intracellular and outside the cells (extracellular). Most of the extracellular water is in the interstitial spaces of the body, outside the confines of the vascular system and the cells. Fluids within the tissue spaces of the body, in conjunction with elastic fibers that form a complex fibro-areolar web in the interstitial spaces, are responsible for many viscoelastic, biomechanical features that characterize clinically-relevant, normal and pathologic tissue states.

The movements of fluid in the interstitial spaces occur relatively slowly because of the numerous points of resistance to the flow of interstitial fluid caused by the complexity of the interstitial space. Even though the interstitial fluid is mostly water, it acts like a high viscosity fluid because it must flow through minute channels around billions of fibers, fat cells and small blood vessels. This observation is important to the realistic simulation of the biomechanical properties of viscoelastic tissues.

### Edema

Edema is a phenomenon in which there is an abnormal accumulation of fluid in the interstitial spaces of a tissue or organ. Clinically-relevant examples include the swelling of tissues in areas of injury or inflammation such as around wounds or sprains. The swelling of the ankles that occurs in patients with heart failure also is caused by edema. Edema changes the shape and turgor of the interstitial spaces altering the mass and the biomechanical properties of the affected tissue. There is an increased in tissue volume and turgor associated with decreased tissue compressibility and elasticity. Internal organs as well as the tissues on the surface of the body cars be affected by edema formation.

Pathologic changes caused by edema are extremely important in medical diagnosis and treatment, particularly when they affect the breathing passages in the mouth, throat and larynx. Edema in the airway is a threat to life winch frequently requires emergency instrumentation or surgical intervention. As will be discussed, the prior art discloses no apparatus or methods to realistically simulate the viscoelastic, biomechanical changes associated with edema.

Prior attempts to simulate tissue edema have typically involved inflation of firm rubber anatomic structures with air, producing elastic, rather than viscoelastic, tissues. The important distinction between the behavior of purely elastic structures and viscoelastic structures has been previously alluded to. The prior art of medical simulation is deficient in that it fails to disclose apparatus and means to create viscoelastic anatomic structures. It follows that the ability to realistically and controllably simulate the changes in biomechanical properties of viscoelastic tissues, including those caused by edema, would be an advance in the realism of simulation-based medical training.

### Birth Canal

Perhaps the most extreme example of viscoelasticity that is seen in biologic tissues occurs in the evolution of the maternal birth canal during parturition.

During the passage of a birthing fetus, the tissues of the uterine cervix, vagina and perineum and the surrounding interstitial tissues dilate and lose tissue volume by virtue of their exceptional viscoelasticity. In order to permit the passage of the fetus, the wall of the vagina must not only stretch but also become extremely thin because the fetus is almost as large as the entire inner circumference of the unyielding bony pelvis.

At the onset of labor, the uterine cervix is a firm, narrow doughnut about an inch thick with a nearly closed lumen. The lumen of the vagina is a couple of centimeters in diameter and the perineum is several centimeters thick.

During labor, the cervix, under pressure from the fetus, loses its thickness and dilates to a diameter 10 cm or more. As labor progresses, the vagina also is forced by the fetus to dilate massively, compressing the surrounding tissue spaces, the rectum and the bladder. Subsequently, the perineum which is about 5 cm thick in its antepartum state, thins to a few millimeters of thickness and 10 cm dilation as the fetus emerges at the vaginal introitus.

The dilation of the birth canal occurs in a sequence from the cervix to the upper, middle, and lower vagina and then the perineum as the pressure of the fetus successively impinges on each of these areas. These tissues lose volume because fluid is displaced from their interstitial spaces under the compression force of the fetus as it is propelled by uterine contraction. The fluid flows through myriad channels to adjacent areas of the body beyond the range of the direct fetal pressure.

The fetus also is a viscoelastic structure. It is deformed by the pressure of the maternal birth canal. The alteration in the shape of the fetal head that commonly occurs during birth is termed “molding.”

After the birth of the fetus, the viscoelastic birth canal and fetus gradually regain their shape, volume, turgor and recover from their deformations over time as fluid that has been displaced from the tissues slowly flows back. Trauma to the tissues of the birth canal and the fetus, incurred during parturition commonly results in mild pathological swelling, i.e., edema, of both the fetus and the birth canal.

The prior art describes various examples of medical simulators, including those discussed in Deering (U.S. Pat. No. 7,997,904), Eggert (U.S. Patent Pub. No. 2008/0138780), Knapp et al. (U.S. Pat. No. 3,797,130), Eggert et al. (U.S. Patent Pub. No. 2013/0330699), Toly (U.S. Patent Pub. No. 2005/0181342), and Allen et al. (U.S. Patent Pub. No. 2007/0172804). However, some of the devices disclosed in the prior art are sufficient for obstetrical simulation.

### SUMMARY OF THE INVENTION

However, there is no prior art obstetrical simulator that includes any viscoelastic tissues in the cervix, vagina or perineum or in the simulated fetus. There are also no medical simulators in the prior art that contain viscoelastic anatomical structures with realistic or controllable biomechanical properties. Prior art birthing simulators are also unrealistic in their lack of intrinsic lubrication systems or simulated bleeding within the birth canal, lack of any viscoelastic properties of the fetus and lack of an apparatus to simulate shoulder dystocia by narrowing the birth canal. Additionally, the birthing simulators of the prior art often have no uterus.

Further, there is no simulator that adequately simulates shoulder dystocia and maneuvers for the relief thereof. Shoulder dystocia is an extremely dangerous but rare complication of childbirth. The anterior shoulder of the baby descending through the birth canal becomes entrapped by the posterior aspect of the maternal pelvis. The fetus is in danger of death if the condition is not relieved within a few minuses. A variety of emergency procedures are used to free the shoulder. Of these, some involve the rotation of the shoulders of the fetus within the lower birth canal. The maneuvers for the relief of shoulder dystocia are dangerous in themselves and can cause disabling complications. The simulators in the prior art are highly unrealistic in this regard, lacking viscoelastic tissues or a viscoelastic fetus to support realistic practice of interventions that would be carried out within the birth canal See, e.g., Allen et al. Further, the prior art does not disclose any apparatus for simulating shoulder dystocia itself by narrowing the pelvis.

Contraction of the uterus in the natural birthing process causes the propulsion of the fetus through the birth canal while lowering the height of the uterine fundus above the maternal pelvis. The prior art discloses pneumatic pressure chambers to propel the fetus through the birth canal. See, e.g., Knapp and Allen. However, because the outer wall of these pressure chambers does not change height above the maternal pelvis to simulate the caudal movement of the fundus, the hard pressure chambers are highly unrealistic and have no capability to support the important maneuver of uterine massage.

There are no examples in the prior art of a simulated fetus having any viscoelastic tissues. For example, the fetus disclosed by Knapp et al. consists of an elastomeric (latex) shell with a polyvinyl chloride gel interior. There is no indication that the gel can flow from one area to another within the fetus as would be required by viscoelasticity. The fetus disclosed by Allen et al. is a rubber baby with skeletal and skull elements. No viscoelastic properties within the fetal simulator are disclosed. The lack of realism impairs training in obstetrical procedures, especially instrumental or operative vaginal delivery.

Leopold maneuvers are a series of procedures to diagnose the orientation of the fetus within the fluid-filled uterus and to rotate the fetus to a head-down orientation before it has engaged in the pelvis. No prior obstetrical simulator permits the performance of Leopold maneuvers using a simulated fetus within a fluid-filled uterus. Prior art simulators for training these maneuvers are extremely primitive. For example, most simulators have no uterus whatsoever and no prior an simulator contains a simulated uterus filled with simulated amniotic fluid and a viscoelastic fetus and placenta.

The numerous deficiencies of the prior art listed above limit the value of simulation training in antepartum and postpartum vaginal examinations, assessment of fetal position, manual and instrumental vaginal delivery, relief of shoulder dystocia, the assessment and treatment of postpartum hemorrhage and the Leopold maneuvers. Thus, there is a need for improved obstetrical simulation devices.

According to an exemplary embodiment, an obstetrical training simulator includes an artificial anatomic structure comprising an artificial tissue structure defining an artificial birth canal that includes an artificial cervix and an artificial vagina. The artificial tissue structure comprises one or more walls enclosing one or more simulated soft tissue spaces. The one or more simulated soft tissue spaces are configured to be reversibly filled with a fluid.

According to one aspect, the simulated soft tissue spaces are in fluidic communication through channels with one or more accessory tissue spaces inside the artificial anatomic structure.

According to one aspect, the simulated soft tissue spaces are in fluidic communication through channels with one or more accessory tissue spaces outside the artificial anatomic structure.

According to one aspect, the simulated soft tissue spaces are in fluidic communication through channels with at least one reservoir.

According to one aspect, fluid shifts between the one or more simulated soft tissue spaces are inducible by applying a surface pressure on the artificial tissue structure.

According to one aspect, the obstetrical training simulator also includes at least one reservoir for a lubrication fluid. The at least one reservoir is in fluid communication with the artificial birth canal and is configured to provide the lubrication fluid to the artificial anatomic structure.

According to one aspect, the obstetrical training simulator also includes at least one reservoir for artificial blood. The at least one reservoir is in fluid communication with the artificial birth canal and is configured to provide the artificial blood to the artificial anatomic structure.

According to one aspect, the obstetrical training simulator also includes an artificial uterus includes an artificial fundus, an artificial uterus body, and a funnel segment at which the artificial uterus is connected to the artificial anatomic structure.

According to one aspect, the obstetrical training simulator also includes an artificial fetus located within the artificial uterus body.

According to one aspect, the artificial fetus comprises an artificial cranium and an artificial scalp, and one or more simulated soft tissue spaces in the artificial cranium are in fluidic communication with one or more simulated soft tissue spaces outside the artificial cranium beneath the artificial scalp.

According to one aspect, the artificial fetus further comprises an artificial torso including an artificial abdomen and an artificial thorax, and one or more simulated soft tissue spaces in the artificial abdomen are in fluid communication with one or more simulated soft tissue spaces within the artificial thorax.

According to one aspect, the one or more walls comprise a hydraulic fluid supplied by a hydraulic pump, the hydraulic pump configured to provide direct hydraulic propulsion to the artificial fetus such that the artificial fetus is propelled out of the artificial uterus body and into the artificial birth canal.

According to one aspect, the artificial fundus and artificial uterus body are configured to move axially so generate a propulsion force on the artificial fetus.

According to one aspect, the obstetrical training, simulator also includes an actuator attached to a posterior portion of the artificial anatomic structure. The actuator comprises a driving mechanism configured to drive the artificial uterus body and artificial fundus towards the funnel segment and further configured to propel the artificial fetus into the artificial birth canal.

According to one aspect, the obstetrical training simulator also includes one or more inflatable bladders disposed adjacent to at least one of an anterior and a posterior position of the artificial tissue structure.

According to one aspect, the one or more inflatable bladders are configured to narrow the artificial birth canal.

According to one aspect, at least a portion of the artificial uterus comprises a soft elastomer and reinforcing struts.

According to one aspect, the obstetrical training simulator also includes a sealable fluid-filled artificial uterus comprising an artificial fetus that is manually rotatable.

According to one aspect, the artificial uterus is configured to cause rotation of the artificial fetus when an external pressure is applied to the artificial uterus.

According to a further exemplary embodiment, a medical training simulator includes an artificial anatomic structure comprising an artificial tissue structure. The artificial tissue structure comprises one or more walls enclosing one or more simulated soft tissue spaces. The one or more simulated soft tissue spaces are configured to be reversibly filled with a fluid.

According to one aspect, the medical training simulator also includes at least one valve configured to control fluid flow between two or more simulated soft tissue spaces.

According to one aspect, the medical training simulator also includes at least one valve configured to control fluid flow between the one or more simulated soft tissue spaces and at least one reservoir.

According to one aspect, the anatomic structure is a birth canal.

According to one aspect, the anatomic structure is a tongue.

According to one aspect, the anatomic structure is a throat.

According to one aspect, the anatomic structure is a body extremity.

According to one aspect, the medical training simulator also includes a programmed microcontroller configured to control an opening and a closing of an at least one aperture of an at least one valve in fluidic communication with at least one of the simulated soft tissue spaces.

According to one aspect, the medical training simulator also includes at least one sensor configured to measure a pressure within the at least one simulated soft tissue spaces.

According to one aspect, the medical training simulator also includes a video monitor and a programmed microcontroller electrically connected to the video monitor. The programmed microcontroller is configured to receive at least one output from the at least one sensor and generate a three-dimensional virtual image on the video monitor based on the at least one output.

According to one aspect, the medical training simulator also includes a fluid disposed within the simulated soft tissue spaces. The fluid has a viscosity greater than a viscosity of water.

### BRIEF DESCRIPTION OF THE DRAWINGS

The accompanying drawings, which are incorporated in and constitute a part of this specification, illustrate embodiments of the invention and together with the description serve to explain principles of the invention.

FIG. 1 is a front perspective view of a simulated multipart uterus and birth canal within the pelvis, according to an exemplary embodiment.

FIG. 2 is sagittal sectional view through the middle of the birth canal and pelvis of the simulator shown in FIG. 1.

FIG. 3 is a lateral perspective view of the uterine fundus and body of the simulator shown in FIG. 1.

FIG. 4 is a coronal sectional view of an interior of an artificial fetus, showing interior fluid spaces of the head, chest, and abdomen of the artificial fetus for use with the simulator shown in FIG. 1.

FIG. 5 is a lateral perspective cutaway view of a Leopold maneuver module showing a fetus and placenta within a fluid-filled lumen of the simulated uterus shown in FIG. 1.

### DETAILED DESCRIPTION OF THE PREFERRED EMBODIMENTS

Training in obstetrical procedures should impart a complex fabric of understanding consisting of cognitive as well as psychomotor elements. The assimilation of this information by trainees to produce practitioners who are proficient in diagnostic and therapeutic procedures is a goal of simulation-based training. It is presumed that the more realistic and relevant the training experience is to the challenges that will be encountered in clinical practice, the more valuable it is. Obstetrical procedures which involve the interaction of the practitioners hands and instruments with the tissues of the mother as well as the fetus are particularly important

Improved simulation capabilities are needed to support training of antepartum and postpartum examinations of the birth canal, maneuvers to relieve shoulder dystocia, operative vaginal delivery and interventions to control postpartum hemorrhage. These capabilities require the advancements in simulated anatomy and artificial tissues disclosed in the present application.

The deficiencies in the prior art, as noted above, are remedied by the present disclosure Improved training in the safe performance of forceps delivery requires high-fidelity tissue simulation in both the mother and the fetus, and currently does not exist in the art. In fact, the absence of any obstetrical simulator possessing tissues with realistic biomechanical properties in the maternal birth canal or the fetus is the most important deficiency of the prior art that is addressed by the present application. Additionally, training in procedures for treating edema will benefit from an improvement in the simulated tissues of the upper airway.

There are a number of additional needs which the present disclosure is designed to meet. There is a need to advance the art related to birthing simulators by developing tissues which have realistic anatomy together with controllable biomechanical properties. It is desirable that the tissues used in simulators for medical training should be not only highly realistic but also durable and resistant to dehydration. There is a need for improved obstetrical simulators to support training of obstetrical practitioners in the performance of these maneuvers. Simulators with realistic birth canal tissues or active mechanisms produce shoulder dystocia are lacking in the prior art. There is a need for improved mechanisms for simulating shoulder dystocia in birthing simulators. There is a particular need to simulate realistic tissues in the lower birth canal where important maneuvers for relieving shoulder dystocia are carried out. Finally, there is a need to provide improved simulation of uterine contraction in birthing simulators. In particular, certain embodiments of the present invention utilize viscoelastic structures, rather than the elastic structures used in prior devices.

The present disclosure relates to an apparatus and system for controlling the dynamic, viscoelastic cervical effacement and dilation and the sequential dilation of the vagina and perineum due to the pressure of a simulated fetus during parturition. The apparatus also provides controlled recovery of the birth canal to an antepartum condition. The present disclosure also relates to an apparatus and system to actively and reversibly narrow the birth canal to simulate shoulder dystocia. The present disclosure also relates to a multipart uterus incorporating a mechanism to simulate the propulsive action of the uterus upon the simulated fetus and the caudal movement of the uterine fundus during parturition. The present disclosure also relates to an apparatus for lubricating the interior of the birth canal. The present disclosure also relates to an apparatus for simulating postpartum hemorrhage within the birth canal. The present disclosure also relates to an artificial fetus including viscoelastic tissues. The present disclosure also relates to a modular apparatus for practicing Leopold maneuvers within a simulated fluid-filled uterus including a viscoelastic fetus.

The systems and methods herein disclosed simulate the alterations that the birth canal undergoes during and after parturition and enable more realistic simulation-based training of practitioners in a number of specific diagnostic and treatment maneuvers. The specific diagnostic and treatment maneuvers include: recognition of the alterations that the cervix and other structures of the birth canal undergo during the progress of labor, diagnosis of the labor station and fetal presentation, delivery of the fetus in various presentations, forceps deliveries, relief of shoulder dystocia, and control of postpartum hemorrhage.

The present disclosure is directed to an obstetrical simulator including an active, viscoelastic birth canal extending from the lower uterus to the vaginal introitus with controllable biomechanical properties, reservoirs and accessory tissue spaces, a multiple-part uterus to simulate contraction and fetal propulsion, a built-in system to lubricate the birth canal, a built-in system to simulate bleeding within the birth canal, a mechanism to reversibly narrow the birth canal, a simulated fetus with viscoelastic tissues, and a module for practicing the Leopold maneuvers.

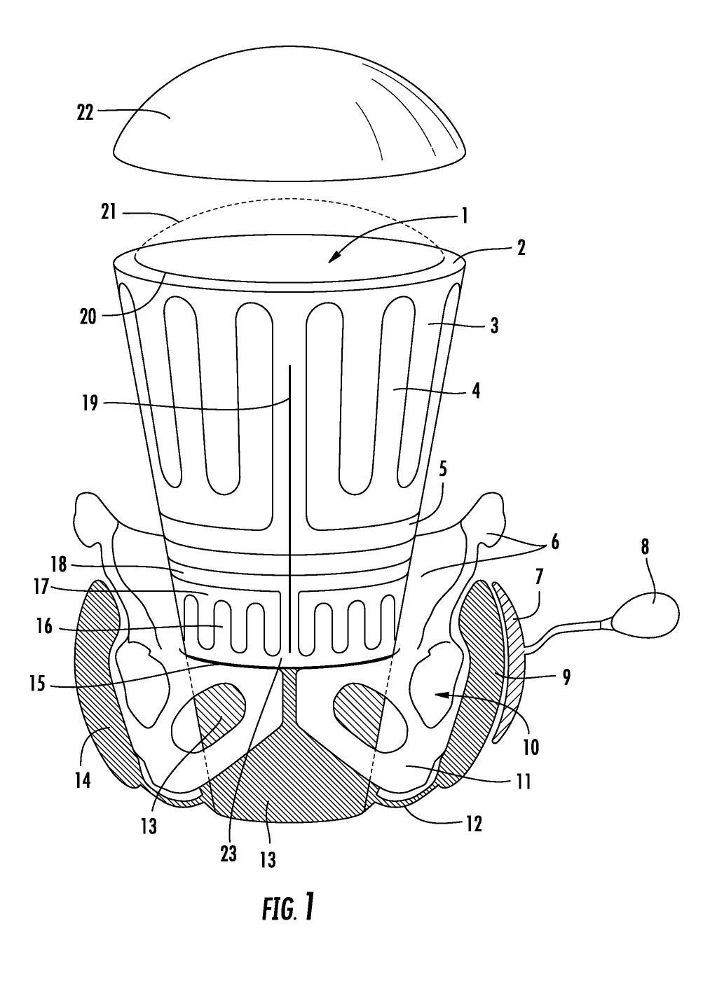

Referring to FIG. 1, a simulated multipart uterus and birth canal within a pelvis is shown. The simulated multipart uterus includes interior body section 1 surrounded by wall 3 which encloses uterus body 2. Wall 3 and uterus body 2 are formed of any suitable material; for example, either or both uterus body 2 and wall 3 are formed of a silicone elastomer. Wall 3 includes a plurality of struts 4 configured to reinforce wall 3 and uterus body 2 of the uterus. According to one aspect, the plurality of struts 4 are connected together with a C-ring (not shown). Uterus body 2 also includes a membrane 5 which is attached between the uterus body 2 and funnel 23. Uterus body 2 rests within bony pelvis 6 which includes acetabulum 10 and ischial bone 11. Bony pelvis 6 is disposed beside accessory tissue spaces 9 and 14. Accessory tissue space 9 rests upon inflatable bladder 7 which is configured to pressurize accessory tissue space 9 and/or an external reservoir. Inflatable bladder 7 is in fluid communication with pressurizing means 8. Pressurizing means 8 is any suitable apparatus or system configured to inflate inflatable bladder 7. For example, pressurizing means 8 includes a mechanical air compressor or hydraulic pump.

Conduit 12 is in fluid communication with accessory tissue spaces 9 and 14. Conduit 12 is configured to transmit fluid from birth canal tissue space (not shown) into accessory tissue spaces 9 and 14. Birth canal outer wall 13 defines the connection between conduit 12 and the birth canal which is joined with funnel 23 of uterus body 2 at junction 15. Funnel 23 includes funnel wall 16 which includes a plurality of struts 17. Funnel wall 16 is formed of any suitable material; for example, funnel wall 16 is formed of a silicone elastomer.

Uterus body 2 also includes vertical loading port 19 which straddles body 2 and funnel 23. The vertical loading port 19 may extend, for example, 70 mm to 160 mm along the body 2, and preferably 100 mm to 130 mm along the body 2. Elastic membrane 18 is disposed at a junction between the uterus body 2 and the funnel 23.

Interior body section 1 of uterus body 2 includes inner thin elastomeric membrane 20 which is configured to line the interior body section 1. According to one aspect, there is a potential space between the membrane 20 and a reinforced silicone wall of interior body section 1. At a top portion of interior body section 1, phantom representation line 21 illustrates the line of the elastomeric lining membrane underside of the inner dome of the fundus 22.

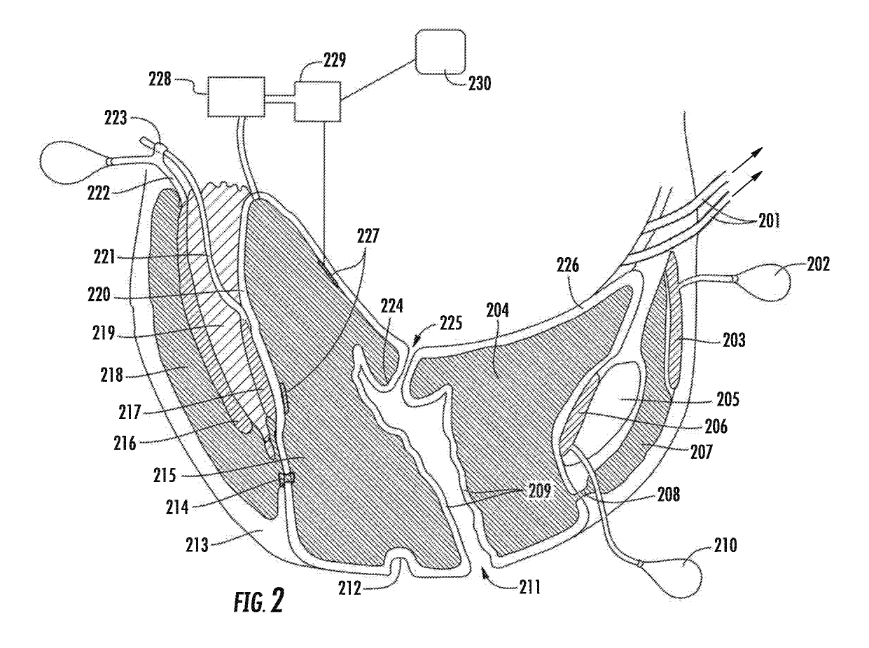

Referring to FIG. 2, a sagittal section through the middle of a birth canal and pelvis is shown. Tubing 201 leads from a remote, external reservoir (not shown) to a lumen of the funnel section of the uterus (such as funnel 23 of uterus body 2, shown in FIG. 1). Tubing 201 is configured to allow the flow of lubricant and artificial blood into uterus body 2 and within inner wall 226 which defines a lumen of the uterus body 2. Pressurizing mechanism 202 is disposed beside accessory fluid space 207. According to one aspect, pressurizing mechanism 202 is the same as the pressurizing means 8 shown in FIG 1. Pressurizing mechanism 202 is in fluid communication with first inflatable bladder 203 (which according to one aspect is the same as the inflatable bladder 7 shown in FIG. 1). Pressurizing mechanism 202 is configured to increase a pressure on the accessory fluid space 207 which is located outside of a pelvis (such as bony pelvic 6 shown in FIG. 1). Accessory fluid space 207 is in fluid communication with channel 208 which fluidly connects accessory fluid space 207 with the at least one simulated soft tissue space 215 of the anatomic structure. According to one aspect, accessory fluid space 207 is inside the anatomic structure; according to a further aspect, accessory fluid space 207 is outside the anatomic structure.

Anterior fluid-filled tissue space 204 of the birth canal is disposed beneath the pelvis (such as bony pelvis 6 of FIG. 1) and beside pubic symphysis 205. Second inflatable bladder 206 is disposed beside tissue space 204. Second inflatable bladder 206 is configured to narrow the birth canal at a level of the public symphysis 205 to simulate shoulder dystocia. Second inflatable bladder 206 is in fluid communication with pressurizing mechanism 210. Pressurizing mechanism 210 is any suitable apparatus or system configured to inflate second inflatable bladder 206. For example, pressurizing means 210 includes a mechanical air compressor or hydraulic pump.

Disposed beneath the pelvis are simulated vaginal walls 209 which include introitus 211. Vaginal walls 209 are connected to the cervix elastomeric walls 224 which define cervix channel 225, which comprises an artificial birth canal of the anatomic structure.

Anal dimple 212 is disposed at a bottom portion of the pelvis and anal dimple 212 is disposed between vaginal introitus 211 and a rear portion of the pelvis which includes tissue of lower body wall 213 and posterior simulated soft tissue space 215 of the birth canal. Simulated soft tissue space 215 surround the cervix walls 224 and a vagina defined by vaginal walls 209. Channel 214 is in fluid communication with simulated soft tissue space 215. Channel 214 includes a valve (not shown) between accessory fluid space 218 (which is located outside the pelvic ring) and simulated soft tissue space 215. The at least one simulated soft tissue space 215 is configured to be reversibly filled with a fluid to produce viscoelastic properties of the anatomic structure. Fluid shifts between the one or more simulated soft tissue spaces 215 are inducible by applying surface pressure on the artificial tissue structure defined by outer wall 220 and inner wall 226. Channel 214 is also in fluid communication with fluid pump 228.

Third inflatable bladder 216 is disposed beside accessory fluid space 218 and is configured to pressurize accessory fluid space 218. According to one aspect, accessory fluid space 218 is inside the anatomic structure; according to a further aspect, accessory fluid space 218 is outside the anatomic structure. Tubing 222 is in fluid communication with third inflatable bladder 216. Fourth inflatable bladder 217 is disposed between inflatable bladder 216 and simulated soft tissue space 215 and is configured to narrow outer birth canal walls 220 for shoulder dystocia movement. Tubing 221 is in fluid communication with fourth inflatable bladder 217. Valve 223 is configured to control a fluid flow in tubings 221 and 222. Outer walls 220 define an exterior of the birth canal and are attached to sacrum 219. Outer wall 220 and inner wall 226 define an artificial tissue structure surrounding cervix channel (i.e., birth canal) 225.

A plurality of pressure sensors 227 are disposed within simulated soft tissue space 215 and are configured to detect a fluid pressure within simulated soft tissue space 215. Pressure sensors 227 are electrically connected to a programmed logic controller 229 which is configured to receive output from the pressure sensors 227 and further configured to regulate fluid pump 228. Programmed logic controller 229 is also further configured to control a computer display of a three-dimensional image of the birth canal and pelvis on computer display screen 230.

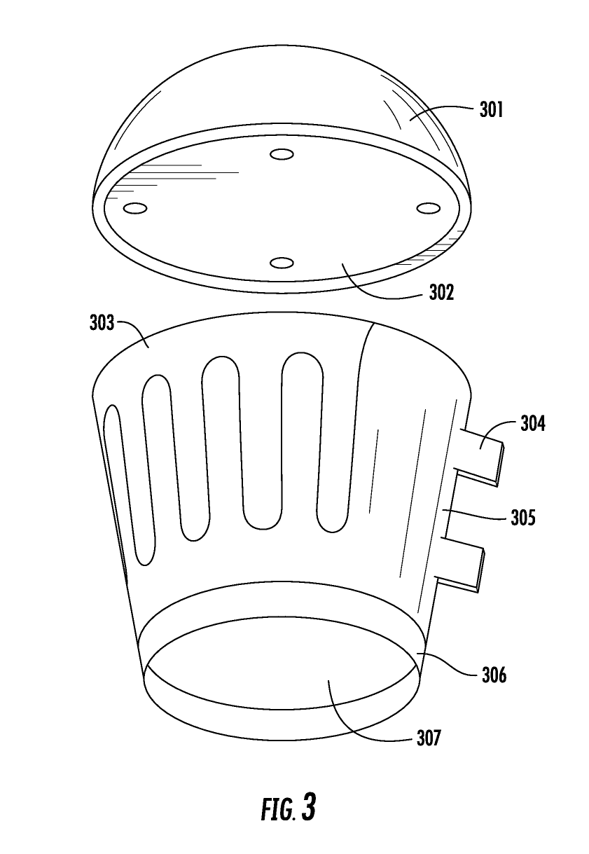

Referring to FIG. 3, a uterine fundus and body are shown. The uterus body (such as uterus body 2 shown in FIG. 1) includes dome 301 (which may be equivalent or similar to dome 22 shown in FIG. 1) which includes inner dome portion 302 having a plurality of pores or channels. The uterus body also includes elastomeric wall 303 having struts 308 and back plate 305 which is in continuity with the struts 308. Back plate 305 is made of any suitable material. For example, back plate 305 is made of hard rubber. As a further example, back plate 305 is made of plastic. Back plate 305 includes projections 304. The uterus body also includes elastomeric lower wall portion 300 which defines lumen 307 of the uterus body.

### Viscoelastic Birth Canal

An active, viscoelastic birth canal extending from the lower uterus to the introitus with controllable biomechanical properties, reservoirs and accessory tissue spaces is disclosed. As has been previously discussed, artificial anatomic structures with hollow interior spaces are well-known in the art. In some of the prior art, tissue spaces have been inflated with air to simulate tissue swelling but the inflated tissue spaces are elastic, not viscoelastic, because there is no mechanism to provide the controlled egress of fluid under the influence of surface pressure. In other words, there is no provision for the viscous or fluid-flow element of viscoelasticity. The biologic fidelity of the tissues suffers by this omission.

Certain embodiments described herein include a combination of artificial, elastomeric, anatomic structures, tissue spaces with pores or channels that allow fluid exit and viscous fluids to simulate and control the biomechanical properties of complex anatomical structures such as the birth canal. Viscoelasticity of the composite anatomic structures is achieved by an actual flow of fluid out of the tissue spaces of the structures under the influence of surface pressure on the structure. Spaces within the artificial organs are constructed so as to permit the flow of the viscous fluid through channels from one tissue space to another or to a reservoir under the influence of surface pressure.

### Control of Biomechanical Properties of Anatomic Structures

Control of the rate and distribution of the flow of fluid from artificial tissue spaces under a given degree of surface pressure is crucial to the regulation of the biomechanical properties of an artificial viscoelastic structure. The importance of the ability to regulate the biomechanical properties of an artificial viscoelastic tissue may be illustrated with reference to altering the properties of the birth canal.

A unique property of the simulator of the present disclosure relates to capabilities for training practitioners in the antepartum examination of the birth canal. The shape and biomechanical properties of the birth canal tissues are regulated by controlling the fluid volume and pressure in the artificial tissue spaces of the anatomic structures. By this means, the birth canal can be dynamically altered to represent that of a patient at any stage or phase of labor.

Sequential dilation and effacement of the cervix under the pressure of the fetus are made possible by viscoelastic cervical and vaginal tissues which are not present in any obstetrical simulators of the prior art. Every stage of labor up to and including fetal expulsion can be simulated without any need to change any parts of the simulator. Commercially available obstetrical simulators such as those marketed by Limbs and Things Inc., require the exchange of the hard rubber cervix portion of the simulator to represent various stages of cervical dilation and effacement.

A programmed logic controller receiving the output from pressure sensors located within the artificial tissue spaces can generate a virtual image of the state of the birth canal, that is how much is dilated. This virtual image may be displayed on a monitor screen. An instructor, controlling the dynamic state of the birth canal and the phases of simulated labor can grade the accuracy of trainee evaluations of the birth canal made by physical examination of the birth canal of the physical simulator. Because the tissues of the physical simulator react dynamically under the influence of the fetal pressure, the birth canal may be made to reflect the condition of a parturient at any stage or phase of labor.

The ability to control the viscoelastic, biomechanical properties of the birth canal by regulating the fluid pressure in various parts of the anatomic structure permits the simulated evolution of the birth canal to occur at any chosen speed. The fluid in various parts of the anatomic structure may be any suitable fluid. As one example, the fluid is a liquid (e.g., a liquid having a viscosity greater than a viscosity of water); as a further example, the fluid is a gel. If the instructor wishes to rapidly train a number of practitioners in the evaluation of the degrees dilation and effacement of the cervix at various stages and phases of labor, the fluid pressure in the tissue spaces of the cervix, vagina and perineum can be reduced at a more rapid pace than would occur in nature so that the labor sequence, alterations of the birth canal and the delivery can be rapidly repeated.

For example, simulated fetal pressure on the cervix may efface it 50% and dilate it to 4 centimeters at a particular point in the labor process. The perineum and vagina will be in non-dilated state. Trainees may examine the birth canal and learn to estimate the degree of cervical dilation and effacement as would be required by clinical practice. The fetus cart be advanced by manual or mechanical means, causing further cervical dilation and effacement and the canal can be re-examined.

In the event that rapid training of numerous practitioners in the vaginal delivery of babies is desired, the viscous resistance of the birth canal can be reduced permitting an accelerated evolution of the birth canal through various stages of dilation and effacement. This is accomplished by allowing the free egress of fluid from the tissue spaces of the walls of the canal under the pressure of the fetus through wide open pores or channels into a low-pressure reservoir. If the reservoir is then pressurized, the birth canal can be rapidly reset for another delivery.

This regulation of the biomechanical properties of tissues may be achieved by multiple mechanisms. For example, resistance to flow from the artificial tissue spaces is regulated by the number, location, dimensions and resistance of ports or channels that penetrate otherwise impermeable surfaces of the anatomic structure separating the artificial tissue spaces from other artificial tissue spaces or from fluid reservoirs. As an additional example, the resistance to flow in or out of tissue spaces is regulated by the differential pressure between two tissue spaces or between a tissue spaces and the reservoir. As yet a further additional example, flow is regulated by valves including manual valves or solenoid valves within the channels that are in fluidic communication between an artificial tissue spaces and a reservoir or between two tissue spaces. As a still further additional example, the control of the biomechanical properties of simulated viscoelastic tissues is also enhanced by the use of fluids having a viscosity greater than water. Combinations of these mechanisms may be employed in a given simulator.

Channels between fluid spaces or between fluid spaces and reservoirs contain valves. These valves can be adjusted by the output of a programmed microcontroller. The control system can receive commands to open or close valves between various tissue spaces and/or reservoirs. The control system can also regulate the pressure within the tissue spaces and thus the size and shape of the anatomic structure containing the tissue spaces.

The fluid space pressures in standardized anatomic structures will have known dimensions when the tissue spaces are tilled with fluids at various pressures. These dimensions and form the basis for a software program that relates pressure to the size and shape of the anatomic structure. The fluid space pressures can be monitored by sensors located within the fluid spaces or in the walls of the fluid spaces. Data from the sensors, interacting with the program of the microcontroller can open and close valves, regulate pressure within any or all fluid compartments, control pumping mechanisms and create virtual images of the shape and dimensions of the anatomic structure at various internal pressures of the tissue spaces. These virtual images can be displayed on a monitor screen.

The tissue spaces according to certain embodiments include a baseline volume for the space at 1 atm pressure. At this level of pressurization the anatomic structure will be in its neutral or baseline state. This baseline state can be scanned using three-dimensional imaging techniques. The baseline three-dimensional image of the anatomic structure at any given pressure within the tissue spaces cart be recorded as three-dimensional computer images.

For example the cervix, vagina and perineum will have normal antepartum dimensions. The elastomeric walls of the anatomic structure enclosing a tissue space may vary in thickness and in the degree of fabric reinforcement depending on the anatomical and biomechanical properties that are simulated. The infusion of a volume of fluid equal to or greater than greater than the baseline volume of the tissue spaces within the anatomic structure will permit the distention or dilation of the anatomic structure. Regulation of the biomechanical properties is achieved by the mechanisms enumerated above.

The thinner areas of the walls of the anatomic structure will tend to “bulge” more than the thicker areas and will have less resistance to compression. Selective thinning and thickening of the walls constituting the surface anatomy of a complex anatomical structure will allow the variation in the shape and resistance of various areas of the same anatomical model. This selective thickening of the walls constituting the surface contour of anatomic models will permit the enhanced simulation of complex biomechanical behaviors of simulated tissues.

The design and fabrication of elastomeric, anatomic models with interior hollow spaces are well-known in the art. According to an exemplary embodiment, the artificial organs and tissues will be fabricated of soft silicone and have hollows, cavities or spaces within their interiors. The shapes of the tissue spaces may conform to the contours of the surface anatomy of the simulated structure or may be independent of it.

In one embodiment, the interior of artificial tissue spaces, enclosed by an elastomeric capsule except in the area of channels or pores, could be filled with viscoelastic foam. The composite structure would be truly viscoelastic so long as it was possible for fluid to exit the tissue space of the structure under a compressive load. The compressibility, weight, turgor, resistance to stretch and other biomechanical properties could be adapted to the imitation of specific biological tissues by varying the density and indentation load deflection of the foam that is employed and/or by saturating the foam with liquids of varying specific gravity and viscosity.

Complex tissue spaces filled with viscous fluid and in fluidic communication with other tissue spaces or reservoirs by means of pores or channels through impermeable, elastic walls of the anatomical analog permit the simulation of realistic biomechanical patterns of tissue compression or deformation when surface pressure is applied to the structure.

The specific properties of liquids, particularly the viscosity are relevant to the biomechanical properties of the artificial viscoelastic tissues in which they are used. It may be easily demonstrated that a balloon filled with air or water has very different biomechanical properties from one that is filled with heavy oil or honey. This is significant because, as was discussed in the prior section on viscoelasticity, interstitial fluid behaves like a very viscous fluid due to the complexity of the spaces. According to an exemplary embodiment, artificial interstitial fluids have a viscosity greater than that of water and preferably many times that of water. The viscosity of water is 1×10⁻³ Pa·s at 20° C. Thus, the viscosity of the artificial interstitial fluid used in embodiments described herein is, for example, greater than 1×10⁻³ Pa·s at 20° C., and more preferably 0.5 Pa·s or greater at 20° C. An example of a fluid that might be used would be liquid silicone, with a viscosity approximately that of heavy oil.

An artificial cervix, vagina and perineum constructed according to the principles disclosed in the present application, will respond to pressure exerted by the birthing fetus with the displacement of fluid from the tissue spaces within the cervix to accessory tissue spaces or reservoirs beyond the birth canal. This will be followed by displacement of fluid from the tissue spaces around the vagina and the perineum as the fetus moves toward the vaginal introitus. The simulated interstitial fluid will pass to accessory tissue spaces or reservoirs outside of the pelvis.

Because the birth canal structures are viscoelastic, there will be no immediate elastic recoil of the canal. The areas dilated by the leading part of the fetus will remain dilated for several minutes as the rest of the fetus passes. The sequential pattern of viscoelastic birth canal dilation and slow recovery will closely simulate the natural process. The size of the fluid outflow ports in fluidic communication with reservoirs or other tissue spaces and the presence or absence of valves can regulate the biomechanical properties of the tissues of the artificial birth canal. Pressurization of the reservoirs or accessory tissue spaces can help regulate the biomechanical properties of the tissues.

The disclosure of Toly, referenced above, is different from the art of the present disclosure and is not enabling for the tissues of the obstetrical training model described in the present application. The “esophageal structure” Toly discloses does not represent a tissue space built into the wall of a complex anatomical analog but is a separate, discrete bladder in fluidic communication with a reservoir, not with the tissue spaces of a simulated anatomical structure. The shape of the underlying anatomic structure containing the bladder is not altered by the infusion of fluid into the bladder. Instead, a space-occupying bladder separate from the underlying anatomy is inflated in the lumen of the anatomic structure. The fluid used in the bladder disclosed by Toly is water.

The apparatus and methods disclosed herein have applications beyond the birth canal and the fetus. For example certain embodiments may be valuable in enhancing the fidelity of simulators that support training in a wide range of medical and surgical procedures including endotracheal intubation and surgical operations in which viscoelastic organs such as the liver must be retracted to gain access to a surgical target

A simulated, edematous tongue, swollen beyond its baseline dimensions by the infusion of viscous fluid into its tissue spaces and provided with one or more pores or channels that permit the slow egress of the fluid into other tissue spaces or a reservoir when the tongue is depressed by a laryngoscope blade, would closely approximate the viscoelastic behavior of a real swollen tongue. A simulated liver with viscoelastic tissues will have highly realistic haptic properties when retracted, for example, during operations on the gallbladder. The gallbladder itself in such a model could be made to simulate the properties of an edematous and inflamed gallbladder. The biomechanical properties of the tongue, the liver or gallbladder are examples of simulated anatomic structures whose biomechanical, viscoelastic properties can be modulated by mechanisms described in this application.

### Infrastructure

The surface of the simulator will be that of a young, pregnant female. The surface is formed of any suitable material. For example, the surface is fabricated of plastics and/or hard rubber and coated with an elastomer, e.g., silicone. The interior of the abdomen and pelvic cavity contains anatomical representations of the uterus and birth canal and simulated interstitial soft tissues. The interior of the abdomen may house an optional uterine propulsion mechanism and controllers for one or more fluid pumps, lubrication and bleeding. The infrastructure may contain one or more fluid reservoirs to contain lubricant, artificial blood and/or simulated interstitial fluid.

The pumps controlling pressure within the reservoirs and/or interstitial spaces may be positive or negative pressure pumps and may be hydraulic or pneumatic. The pump function is controlled by a programmed logic controller which receives feedback from pressure sensors located in the artificial tissue spaces of the anatomic structures. The same logic controller is also programmed to control an actuator that provides related uterine propulsion of the fetus.

The base of the infrastructure will comprise a tilting mechanism permitting the tilting of the platform/base on which the simulated patient lies, head up or head down 30 degrees. The base may also contain permanent or simulated leg braces or stirrups to allow lower limbs of the manikin to be placed in the lithotomy position.

The base of the infrastructure will also comprise a fluid catchment tub with drainage holes that can be attached to tubing.

### Birth Canal

The birth canal and other pelvic anatomical structures are fabricated to fit within a hard elastomeric model of a female pelvis and sacrum. The outer circumference of the birth canal is attached to the side walls of the bony pelvis.

The upper part of the birth canal is a soft elastomeric structure modeled on the three-dimensional anatomy of the lower 2-6 inches of a pregnant uterus, including the un-ripened cervix. This elastomeric structure has inner and outer walls enclosing a space following the contours of the inner and outer walls of the lower uterus and cervix of a female patient in advanced pregnancy. The tissue space is impermeable except where it is in fluidic communication through pores, tubes or channels with reservoirs or other tissue spaces located in simulated anatomic structures beyond the outer wall of the uterus.

The upper part of the birth canal is in physical continuity with a simulated vagina containing inner and outer walls to encompass a tissue space between the inner and outer walls. The walls of the lower uterus, vagina and perineum will be impermeable except where fenestrated by pores or channels capable of fluidic communication with other artificial tissue spaces or a reservoir.

The walls of the vagina and perineum are fabricated of silicone or a similar soft elastomer. The elastomeric outer and inner walls encompassing circumferentially the space in the walls of the vagina will each be approximately 2-5 mm thick. The walls of the anatomic structures may be reinforced with fabrics such as nylon fabric.

The tissue space enclosed by the inner and outer walls of the lower uterus and cervix may be in fluidic communication through pores or channels with the tissue space of the vagina and/or with a reservoir. Alternatively the tissue spaces of the uterus may be completely separated by an impermeable barrier from the tissue spaces of the vagina and in communication only with a reservoir. In an exemplary embodiment, the tissue spaces of the cervix, vagina and perineum are in fluidic communication with each other.

The fluidic communication between the tissue spaces of any two structures of the anatomic model or between a tissue space within a structure of the anatomic model and one or more reservoirs may contain valves, including solenoid valves. The tissue spaces of the vagina may be in fluidic communication through pores or channels with the tissue spaces of the perineum or may be in fluidic communication only with one or more reservoirs.

The junction between the tissue spaces of the lower uterus and the upper vagina are aligned in an appropriate an atomic plane with the pubic arch sad sacrum of the simulated maternal pelvis.

When the spaces between the inner and outer walls of the lower uterus, cervix, vagina and perineum are filled with fluid at approximately 1 atm pressure they will form an accurate model of the antepartum birth canal. A three-dimensional scan of this anatomic structure is made. The dimensions of the structure at varying levels of fluid volume and tissue space pressures as determined by pressure sensors will also be scanned. In this way a reference document will be produced that can virtually display the dimensions of the various sections of the birth canal at various fluid volumes and pressures. The value of this capability will be discussed below.

In continuity with the vagina is a hollow elastomeric model of the soft tissues of the lower pelvis including the soft tissues and skin of the perineum, medial thigh and buttocks. This anatomic model incorporates interstitial tissue spaces which may be in fluidic communication with the space between the inner and outer wall of the vagina, other soft tissue spaces or reservoirs. The perineal surface of this structure has representations of the anus, vulva, labia clitoris and urethral orifice models to simulate the anatomy of a normal young female.

The birth canal is one element of the pelvic anatomy which may, in certain embodiments, also include a simulated bladder and rectum as well as representations of the surrounding interstitial tissues. The simulated bladder and rectum will have internal and external surface contours that simulate the normal anatomy of the analogous natural structures and have anatomically correct relationships to the simulated lower birth canal. The soft tissue between the rectum and the sacrum or between the rectum and the birth canal may incorporate hollow interstitial spaces or an inflatable bladder able when inflated to exert pressure on the posterior aspect of the birth canal, narrowing it.

An inflatable balloon is attached to the posterior aspect of the pubic arch which, when inflated with air or liquid, presses on the tissue spaces of the lower uterus and upper vagina narrowing the birth canal at this location.

In another embodiment, viscoelastic foam and/or random direction fibers may be used as fillers within the interstitial tissue spaces. The simulated interstitial spaces in this embodiment also are in fluidic communication with reservoirs or with other tissue spaces in the walls of the simulated birth canal.

During simulated childbirth, the fetus is propelled down the birth canal by manual, hydraulic or mechanical force. The apparatus that enables these propulsive forces is discussed below. The pressure of the head of the simulated fetus, impinging on the cervix forces fluid from the tissue space between the walls of the lower uterus and cervix. Fluid is displaced centrifugally through pores or channels in the outer wall of the anatomic structure into adjacent tissue spaces or reservoirs. This displacement of fluid causes the cervix to become thinner as its inner and outer elastomeric walls are forced together. Simultaneously, the pressure of the fetus will dilate the cervix. In another embodiment, fluid may be actively pumped from the interstitial spaces to dilate and efface the cervix and lower birth canal even in the absence of fetal pressure on the anatomic structures of the canal.

According to an exemplary embodiment, dilation and thinning of the cervix result from the pressure of the fetus as it is propelled through the canal. As the fetus descends, fluid in the tissue space between the inner and outer walls of the vagina extrudes through pores or channels into surrounding tissue spaces or reservoirs. The vagina becomes widely dilated as the fluid is expressed from between its walls. The birth canal exhibits true viscoelasticity. It tends to remain dilated as the fetus passes through it without strong elastic recoil of the vaginal tissues. After parturition, it will gradually recover as there is a rebalancing between the pressures in the reservoirs and those in the vaginal walls. As previously indicated, active pumping mechanisms can be used to alter the dimensions of the birth canal in other embodiments.

With the cervix and vagina already dilated, the tissue spaces within the perineum come under the compressive influence of the fetus propelled by the simulated uterine contractions. The fluid volume of the perineum is reduced as the fluid is displaced into surrounding tissue spaces or reservoirs. The tissues become thin and dilate. At this point, the fetus can be delivered using manual or instrumental techniques.

The pattern, number and size of pores or channels leading from the artificial tissue spaces of the cervix, vagina and perineal tissue spaces into surrounding tissue spaces and/or into reservoirs, together with the regulation of the differential pressure between the birth canal tissue spaces and the reservoirs control the rate at which fluid can be expressed from the birth canal structures.

These mechanisms represent an actual control of the biomechanical properties of the canal including the viscoelastic resistance that it offers to the fetus. Friction in the birth canal is further reduced by an intrinsic lubrication mechanism.

A high pressure differential and open pores or valves between the tissue spaces of the birth canal and the surrounding tissue spaces or reservoirs allows the rapid extrusion of fluid from the tissue spaces of the uterus, cervix, vagina and perineum with rapid dilation. Narrowing of the pores or channels or increasing the pressure in the reservoirs or accessory tissue spaces slows the extrusion of fluid from the walls of the birth canal, increasing the viscoelastic resistance of the canal. According to an exemplary embodiment, pressure and volume regulation within the tissue spaces and the opening and closing of valves between spaces and reservoirs are governed by a programmed logic controller. In another embodiment, simple manual controls and hand operated pumps may be used.

The ring of the viscoelastic perineum may be interrupted in one or more locations by one or more permanent slits that are fabricated in the tissue, extending outward from the introitus to simulate episiotomy incisions. These can be held closed by grips, snaps, buttons or Velcro until the practitioner/trainee decides that an episiotomy is needed. Once the determination is made that an episiotomy is required, trainee simulates the procedure by opening the simulated incision. According to an exemplary embodiment, the episiotomy incisions may contain replaceable inserts containing representations of the local anatomy which can be repaired with sutures. The replaceable inserts may be made of elastomers such as silicone or viscoelastic foam incorporating laminations of random direction fiber fabric or may be fabricated from polyvinyl alcohol hydrogel. The tissue inserts may be held in place by molded recesses in the viscoelastic tissues of the perineum.

The viscoelastic birth canal spontaneously recovers following fetal expulsion. The rate at which the tissue spaces are refilled is regulated by controlling the differential pressure between the uterine, vaginal and perineal tissue spaces and the reservoirs or surrounding tissue spaces. Valves assist in controlling the rate of fluid transfer. Rapid refilling of the displaced birth canal tissue fluid can be accomplished by increasing the pressure on the fluid in the reservoirs or in tissue spaces that are in fluidic communication with the birth canal fluid.

### Birth Canal Fabrication and Bleeding

The spaces between the walls of the lower uterus, vagina may be traversed by channels or tubes attached to a pressurized reservoir containing lubricant fluid or artificial blood. The lumen of the lower uterus or vagina contains one or more outlets for lubrication fluid or artificial blood.

### Multipart Uterus

The uterus has three sections that together form a functionally unitary structure. The sections of the uterus are the fundus, body and lower segment. According to one exemplary embodiment, the fundus and body are permanently attached to each other and the uterine body is reversibly attached to the lower uterine segment.

### Fundus

The fundus of the simulated uterus will be fabricated using a elastomer such as silicone and will contain one or more tissue spaces. In an exemplary embodiment, the tissue space of the fundus will be crescent-shaped or lens shaped. The outer wall of the space will be the dome of the fundus. The floor or inner wall of the crescent will constitute an inner dome of the fundus. The inner dome will be fabricated of hard rubber or plastic. The fundus of the uterus will be permanently attached to the top of the body of the uterus to form a functional unit. The tissue space in the fundus is, according to one aspect, filled with a liquid. The tissue space in the fundus will be in fluidic communication through one or more pores, channels or tubes with tissue spaces in the top wall and/or side walls of the cylindrical uterine body.

Manual or mechanical pressure on the outer dome of the fundus displaces fluid from the issue space between the outer and inner dome through pores channels or tubes into potential space between the lining and outer wall of the uterine body. Mechanical or manual pressure or massage of the fundus causes the gradual displacement of the fluid from the tissue space of the fundus bringing the soft outer dome into contact the hard inner douse of the fundus. This displacement of fluid reduces the overall height of the fundus and gives the tactile sensation during massage of the fundus that it has become firm. The fluid transferred from the tissue space of the fundus into the body of the uterus under the inner dome places hydraulic pressure on a fetus that has been positioned within the body of the uterus. This hydraulic pressure assists in the propulsion of the fetus through the lower uterus and into the birth canal.

### Body of the Uterus

The uterine body will be a tapering cylinder approximately 6 inches wide at its upper end and approximately 4 inches wide at its lower end.

It is composed of silicone elastomer reinforced with struts or ribs made out of plastic or hard rubber. The overall thickness of the wall of the uterine body according to an exemplary embodiment is 10 to 30 mm. Walls of the uterine body section of the uterus are made of soft elastomers such as silicone reinforced with bars, struts or ribs made of hard rubber, plastic or metal.

The ribs or struts of the uterine body are in continuity with a hard plastic or rubber plate posteriorly. The ribs or struts of the uterine body are attached to a plate of solid plastic, hard rubber or metal that is part of the posterior wall of the body of the uterus. The plate has features that permit reversible attachment of the posterior plate to the actuator of a driving mechanism.

The struts are attached to each other at one or more points to form, in conjunction with the posterior plate a structure extending from the top to the bottom of the cylinder of the uterine body. The cage formed by the combination of the struts and the plate within the silicone rubber is nearly complete except vertical gap in the ring anteriorly. The solid reinforcements of the silicone wall form a composite structure which prevents bending or folding of the body of the uterus under axial loading or vertical compression. The ring formed by the ribs or struts will elastically resist radial expansion and compression. The posterior aspect of the body of the uterus will contain one or more fin-like projections from the posterior plate.

The projections from the posterior uterus will be closely fitted into the slots or grooves in the simulated posterior abdominal wall. Manual or mechanical pressure along the axis the uterus will cause the entire fundus and body move as a unit along a defined track toward the lower uterine segment. The uterine body is permanently attached to the fundus superiorly and reversibly attached to the lower uterine section interiorly.

The lining of the body of the uterus constitutes a separate layer from the outer structural wall of the body of the uterus that is composed of silicone with reinforcing struts. The lining of the body of the uterus is a soft elastomer such as silicone proximally 1 to 2 mm thick which, according to one aspect, is reinforced with nylon fabric or similar elastic fabrics. A potential space will exist between the lining of the uterine body and the reinforced outer wall of the uterine body. The potential space between the lining and structural wall may contain viscoelastic foam.

According to one aspect, the potential space between the lining and the outer reinforced silicone wall of the uterine body can be infused with hydraulic fluid supplied by an hydraulic pump so that the uterine body can provide direct hydraulic propulsion to the fetus.

The motion of the uterine fundus and body toward the pelvis simulates uterine contraction with fetal propulsion. The fetus, previously loaded in the desired position within the body of the uterus will be delivered into the birth canal through the funnel by the motion of the entire body of the uterus toward the lower birth canal.

The driving mechanism of the actuator exerts force along the longitudinal axis of the uterine body. The force of the actuator will be transmitted to the plate of the posterior uterus and from that plate to the reinforcing struts that are in continuity with it. The application of axial force will drive the entire uterine body and fundus toward lower uterine segment and the birth canal. The fetus previously positioned within the body of the uterus will be propelled into the funnel the birth canal by the movement of the uterine body. The actuator for the uterine propulsion mechanism is, according to one aspect, a stepper motor controlled by a programmed logic controller.

According to another aspect, the uterine body is stationary and fetal propulsion occurs as the result of hydraulic forces exerted within the body of the uterus by pressurized fluid infusing beneath the membrane lining and body and the outer wall of the uterus. In this aspect, a fluid pump infuses a liquid between the inner and outer layers of the uterine body and fundus, exerting propulsive forces on the fetus. The uterine body is reversible attached to the funnel constituting the lower uterine segment by reinforced soft elastomeric material such as silicone reinforced with nylon fabric. The uterine fundus and body section of the multipart uterus can be completely removed from the infrastructure for cleaning or for the substitution of a Leopold maneuver module, described below.

### Lower Uterine Segment

The lower uterine segment constitutes a tapering cylinder or funnel approximately 5 inches wide at its top-end and 4 inches wide at its lower end. The funnel is composed of a soft elastomer such as silicone reinforced with struts forming a nearly complete circle that is broken anteriorly. There is no posterior plate in the funnel/lower uterine segment. The upper end of the funnel is reversibly attached to the lower body of the uterus. A soft elastic membrane bridges the gap between the lower end of the uterine body and the top of the funnel, allowing the two sections to operate as part of the functional unit of the complete uterus. The lower end of the funnel is permanently attached to the upper end of the birth canal. The lumen of the funnel contains one or more ports receiving for lubrication fluid and or blood from pressurized reservoirs.

### Shoulder Dystocia Mechanism

The devices described herein include several, unique active mechanisms for producing shoulder dystocia at the level of the of the maternal pubic arch.

According to one aspect, the narrowing of the birth canal is achieved by the inflation of a bladder located between the posterior pubic arch and the anterior wall of the birth canal. Inflation of the bladder with liquid or air narrows the birth canal behind the maternal pubic arch.

According to a further aspect, the narrowing of the birth canal is achieved by a firm bar that descends from the posterior aspect of the pubic arch to impinge on the anterior wall of the birth canal. In another embodiment, narrowing of the birth canal was achieved by posterior displacement of a section of the maternal pubic arch.

According to a still teller aspect, narrowing of the birth canal is achieved by the inflation of a space occupying bladder in the soft tissues posterior to the birth canal. The action of this bladder pushes the fetus anteriorly, trapping the anterior shoulder under the maternal pubic arch. In another embodiment, the birth canal can be reversibly narrowed by the inflation of a space-occupying bladder within the area of the maternal rectum.

### Viscoelastic Fetus

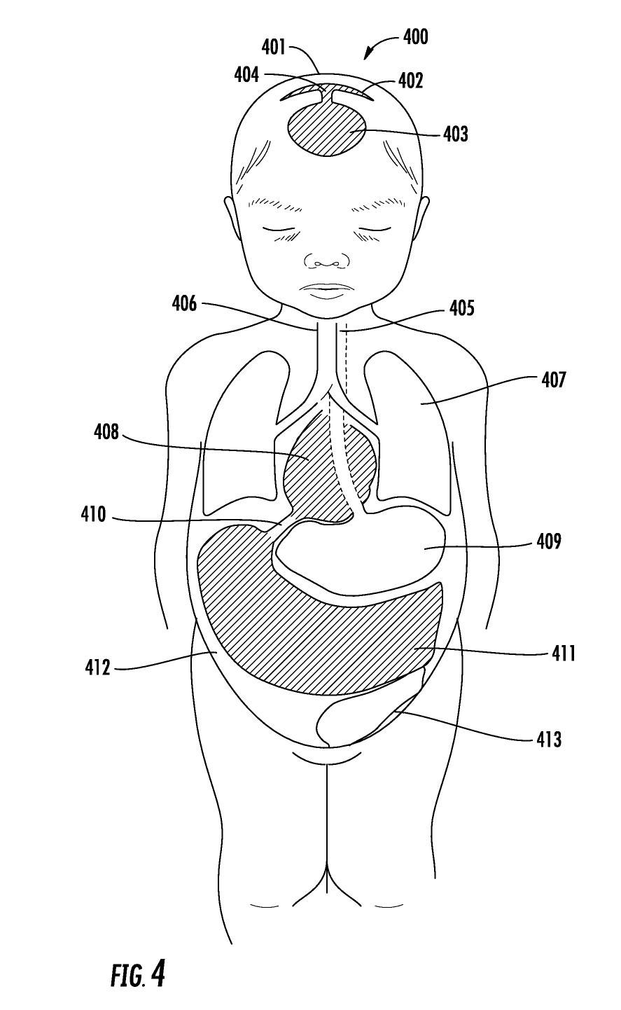

Referring to FIG. 4, a partial sectional view of an artificial fetus 400 is shown. Artificial fetus 400 includes body wall 412, defining an outer extent of fetus 400 and scalp 401, accessory fluid space 402 disposed beneath scalp 401 that is in fluid communication with intra-cranial fluid space 403. Channel 404 connects fluid space 402 with infra-cranial fluid space 403.

Fetus 400 also includes molded esophageal channel 405 and molded tracheal and bronchial channels 406 disposed within an body portion of the fetus 400. Fetus 400 also includes molded lung space 407 and fluid space 408 surrounded by lung space 407 and disposed above molded gastric space 409. Channel 410 connects abdominal fluid space 411 with fluid space 8. Abdominal fluid space 411 is disposed in an abdominal portion of fetus 400. Molded colon or rectal space 413 is disposed at a bottom portion of body wall 412 and beneath abdominal space 411.

As has been previously discussed, a normal human let its has viscoelastic tissues which are acted upon by the maternal birth canal during childbirth. The emulation of biomechanical properties of these tissues is important to the development of a realistic obstetrics simulator. Liquid-containing tissue spaces communicating by narrow channels within the torso and head of the artificial fetus impart viscoelastic properties to the tissues of these anatomic structures.

An artificial fetus constructed according to the principles disclosed herein will respond to pressure exerted on the sides of the head by displacing a small amount of fluid from the tissues inside of the skull through a channel created for the purpose to a selected tissue space between the bones of the skull and the scalp. This artificial mechanism will be regulated by the apparatus and methods disclosed in this application to imitate the transient molding of the fetal skull and the collection of fluid between the outer skull and scalp, simulating the commonly observed “caput succedaneum.” The mechanisms disclosed in the present application will permit the resolution of this transient molding by manual pressure on the affected area of the scalp.

As is true in an actual human fetus, pressure on the abdomen displaces the abdominal contents toward the chest. Increased pressures in the chest cause the abdomen to bulge. These viscoelastic properties are imparted to the artificial fetus by the inclusion within the body and head of tissue spaces filled with fluid. In one aspect, this is a high viscosity liquid.

The fetus is composed principally of a soft elastomer, according to one aspect, soft durometer silicone. Skeletal elements including plastic or hard rubber analogues of the rib cage, spine, pelvis, shoulder girdle and major long bones are incorporated in the molded fetus. Simulated plates of the fetal skull are also incorporated in the model. According to an exemplary embodiment, there are bendable wires crossing the joints between the long bones which allow the limbs to be posed in variable degrees of extension or flexion.

Tissue spaces are incorporated within the silicone tissues of the head, thorax, abdomen and pelvis. These tissue spaces are filled with viscous fluid, preferably viscous silicone liquid. These spaces are in fluidic communication with each other or with reservoirs through one or more narrow channels, pores or tubes.

Also within the interior of thorax are two additional spaces approximating the size and shape of fetal lungs that are in fluidic communication through tubes or channels with the mouth and throat of the simulated fetus but not with other tissue spaces. Within the upper abdomen and lower chest a soft tissue space roughly corresponding to the size of the fetal stomach is molded. The space is in fluidic communication through channels or tubing with the mouth of the fetus. In another embodiment, a tissue space corresponding to the course of the fetal colon may be incorporated. This space, with an outlet at the anus can be inflated with air or simulated intestinal contents. In the latter case, can be used to simulate the passage of meconium by a fetus in distress.

The interior of the cranium is principally occupied by soft silicone elastomer within which a simulated tissue space is molded. This space is in fluidic communication with a potential space molded between the scalp and the bones of the skull. The tissue space within the head is filled with a highly viscous fluid consisting, for example of liquid silicone. Pressure on the plates of the skull displaces fluid from the tissue space inside the head to the tissue space beneath the crown of the scalp. Pressure on the scalp displaces fluid from the tissue space under the scalp back into the cranium.

The chest, abdomen and pelvis of the simulated fetus also have tissue spaces in fluidic communication with each other or with accessory fluid spaces or reservoirs. These tissue spaces are also filled with liquid silicone elastomer or other high viscosity fluid. The molded tissue spaces corresponding to the lungs and stomach are communication with the atmosphere and contain only air under normal circumstances.

### Leopold Maneuver Module

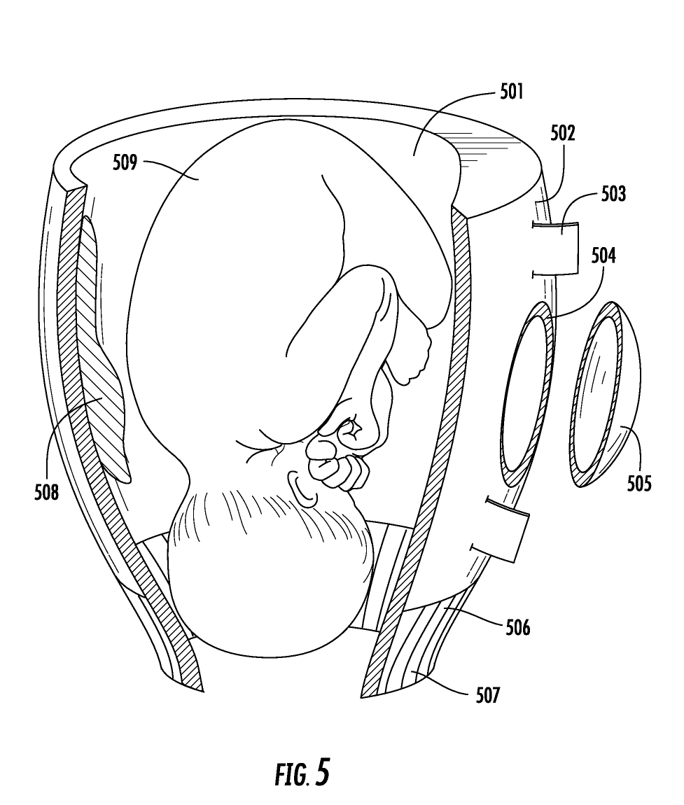

Referring to FIG. 5, a Leopold module is shown. The module includes a fetus 509 disposed within a fluid-filled uterus 501. A placenta 508 is also disposed within uterus 501 and beside fetus 509. Uterus 501 includes a back plate 502 having a projection 503 and a portal 504. Cap 505 is releasably secured to portal 504 such that fluid-filled uterus 501 is fluidically sealed. Uterus 501 is defined by elastomeric wall 506 having a tapered end 507 at one end of the uterus 501. Tapered end 507 is configured to be inserted into a funnel (not shown).

As previously indicated, the fundus and body of the multi-section propulsive uterus are reversibly attached from the lower uterine segment. For practice of the Leopold maneuvers, the body and fundus of the uterus are removed and replaced with a module designed specifically for this purpose. The module fits within the abdominal space from which the fundus and body of the multipart uterus have been removed and its lower end inserts into the lower uterine segment.

The module has a shape which closely approximates that of the fundus and body of the multipart uterus with a hard rubber posterior wall containing the fin-like projections identical to those present on the posterior aspect body of the multi-part uterus. The module is a sealed chamber with a wall made of soft elastomer, preferably silicone. The wall is reinforced with multiple layers of nylon mesh. The wall of the module approximates the thickness of a full-term uterus prior to the onset of labor.

The posterior aspect of the module is made of firm rubber or plastic with fin-like projections similar to those on the posterior of the body of the multipart uterus. These projections permit the posterior aspect of the Leopold module to fit into the slots or grooves in the posterior abdominal wall, stabilizing the modular unit.

The interior of the module contains a full-term fetus constructed as described above and a placenta. The placenta is attached to the inner aspect of the wall of the module. In addition to the fetus and placenta, the interior of the module is filled with fluid, preferably silicone fluid.

According to an exemplary embodiment, the module may have an opening port, approximately 5 inches in diameter, in its posterior aspect through which fluid, the fetus and/or the placenta can be removed and replaced.

Comprise, include, and or plural forms of each are open ended and include the listed parts and can include additional parts that are not listed. And/or is open ended and includes one or more of the listed parts and combinations of the listed parts.

As used in this application, the terms “component,” “module,” “system,” and the like can refer to a computer-related entity, either hardware, firmware, a combination of hardware and software, software, or software in execution. For example, a component cast be, but is not limited to being, a process running on a processor, an integrated circuit, an object, an executable, a thread of execution, a program, and or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and or across a network such as the Internet with other systems by way of the signal).

Moreover, various functions described herein can be implemented in hardware, software, firmware, or any combination thereof. If implemented in software, the functions can be stored on or transmitted over as one or more instructions or code on a computer-readable medium. Computer-readable media is non-transitory in nature and includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any physical connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc (BD), where disks usually reproduce data magnetically and discs reproduce data optically with lasers. Combinations of the above should also be included within the scope of computer-readable media.

Other embodiments will be apparent to those skilled in the art from consideration of the specification and practice of the embodiments disclosed herein. It is intended that the specification and examples be considered as exemplary only.

What is claimed is:

1. An obstetrical training simulator comprising:
an artificial anatomic structure comprising an artificial tissue structure defining an artificial birth canal that includes an artificial cervix and an artificial vagina;
wherein the artificial tissue structure comprises one or more walls enclosing one or more simulated soft tissue spaces, and
wherein the one or more simulated soft tissue spaces are configured to be reversibly filled with a fluid.

2. The obstetrical training simulator of claim 1, wherein the simulated soft tissue spaces are in fluidic communication through channels with one or more accessory tissue spaces inside the artificial anatomic structure.

3. The obstetrical training simulator of claim 1, wherein the simulated soft tissue spaces are in fluidic communication through channels with one or more accessory tissue spaces outside the artificial anatomic structure.

4. The obstetrical training simulator of claim 1, wherein the simulated soft tissue spaces are in fluidic communication through channels with at least one reservoir.

5. The obstetrical training simulator of claim 1, wherein the artificial tissue structure is configured such that fluid shifts between the one or more simulated soft tissue spaces are inducible by applying a surface pressure on the artificial tissue structure.

6. The obstetrical training simulator of claim 1, further comprising at least one reservoir for a lubrication fluid,
wherein the at least one reservoir is in fluid communication with the artificial birth canal and is configured to provide the lubrication fluid to the artificial anatomic structure.

7. The obstetrical training simulator of claim 1, further comprising at least one reservoir for artificial blood,
wherein the at least one reservoir is in fluid communication with the artificial birth canal and is configured to provide the artificial blood to the artificial anatomic structure.

8. The obstetrical training simulator of claim 1, further comprising an artificial uterus comprising:
an artificial fundus;
an artificial uterus body; and
a funnel segment at which the artificial uterus is connected to the artificial anatomic structure.

9. The obstetrical training simulator of claim 8, further comprising an artificial fetus located within the artificial uterus body.

10. The obstetrical training simulator of claim 9,
wherein the artificial fetus comprises an artificial cranium and an artificial scalp, and
wherein one or more simulated soft tissue spaces in the artificial cranium are in fluidic communication with one or more simulated soft tissue spaces outside the artificial cranium beneath the artificial scalp.

11. The obstetrical training simulator of claim 10,
wherein the artificial fetus further comprises an artificial torso including an artificial abdomen and an artificial thorax, and
wherein one or more simulated soft tissue spaces in the artificial abdomen are in fluid communication with one or more simulated soft tissue spaces within the artificial thorax.

12. The obstetrical training simulator of claim 9, wherein the one or more walls comprise a hydraulic fluid supplied by a hydraulic pump, the hydraulic pump configured to provide direct hydraulic propulsion to the artificial fetus such that the artificial fetus is propelled out of the artificial uterus body and into the artificial birth canal.

13. The obstetrical training simulator of claim 12, wherein the artificial fundus and artificial uterus body are configured to move axially to generate a propulsion force on the artificial fetus.

14. The obstetrical training simulator of claim 9, further comprising an actuator attached to a posterior portion of the artificial anatomic structure,
wherein the actuator comprises a driving mechanism configured so drive the artificial uterus body and artificial fundus towards the funnel segment and further configured to propel the artificial fetus into the artificial birth canal.

15. The obstetrical training simulator of claim 8, further comprising one or more inflatable bladders disposed adjacent to at least one of an anterior and a posterior position of the artificial tissue structure.

16. The obstetrical training simulator of claim 15, wherein the one or more inflatable bladders are configured to narrow the artificial birth canal.

17. The obstetrical training simulator of claim 8, wherein at least a portion of the artificial uterus comprises a soft elastomer and reinforcing struts.

18. The obstetrical training simulator of claim 1, further comprising a scalable fluid-filled artificial uterus comprising an artificial fetus that is manually rotatable.

19. The obstetrical training simulator of claim 18, wherein the artificial uterus is configured to cause rotation of the artificial fetus when an external pressure is applied to the artificial uterus.

20. A medical training simulator comprising:
an artificial anatomic structure comprising an artificial tissue structure,
wherein the artificial tissue structure comprises one or more walls enclosing one or more simulated soft tissue spaces, and
wherein the one or more simulated soft tissue spaces are configured to be reversibly filled with a fluid.

21. The medical training simulator of claim 20 further comprising at least one valve configured to control fluid flow between two or more simulated soft tissue spaces.

22. The medical training simulator of claim 20 further comprising at least one valve configured to control fluid flow between the one or more simulated soft tissue spaces and at least one reservoir.

23. The medical training simulator of claim 20, wherein the artificial tissue structure defines an artificial birth canal.

24. The medical training simulator of claim 20, wherein the anatomic structure is an artificial tongue.

25. The medical training simulator of claim 20, wherein the anatomic structure is an artificial throat.

26. The medical training simulator of claim 20, wherein the anatomic structure is an artificial body extremity.

27. The medical training simulator of claim 20, further comprising a programmed microcontroller configured to control an opening and a closing of an at least one aperture of an at least one valve in fluidic communication with at least one of the simulated soft tissue spaces.

28. The medical training simulator of claim 20, further comprising at least one sensor configured to measure a pressure within the at least one simulated soft tissue spaces.

29. The medical training simulator of claim 28, further comprising a video monitor and a programmed microcontroller electrically connected to the video monitor,
wherein the programmed microcontroller is configured to receive at least one output from the at least one sensor and generate a three-dimensional virtual image on the video monitor based on the at least one output.

30. The medical training simulator of claim 20, further comprising a fluid disposed within the simulated soft tissue spaces,
wherein the fluid has a viscosity greater than a viscosity of water.
